(19) United States
(12) Patent Application Publication
(10) Pub. No.: US 2021/0337174 A1
(43) Pub. Date: Oct. 28, 2021

(54) VIDEO CONTENT MEDIUM AND VIDEO REPRODUCTION APPARATUS

(71) Applicant: Mitsubishi Electric Corporation, Tokyo (JP)

(72) Inventors: Kosuke YAGI, Tokyo (JP); Nobuo TAKESHITA, Tokyo (JP); Masaaki SHIMADA, Tokyo (JP); Tomo KISHIGAMI, Tokyo (JP); Yoshinori WATANABE, Tokyo (JP)

(73) Assignee: Mitsubishi Electric Corporation, Tokyo (JP)

(21) Appl. No.: 16/625,564

(22) PCT Filed: Aug. 23, 2017
(86) PCT No.: PCT/JP2017/030085

§ 371 Date: Dec. 20, 2019

(51) Int. Cl. H04N 9/78; H04N 9/82; H04N 9/793

(52) U.S. Cl. CPC H04N 9/78; H04N 9/793; H04N 9/8238

(57) ABSTRACT

In a format in which a graphic is transmitted to a display apparatus after being combined with a content video, luminance of the graphic is fluctuated by dynamic metadata control. A video content medium relating to technology disclosed in the description of the present application is a video content medium on which one or more video streams, control information, and graphic information including a menu or a subtitle are recorded, wherein at least one of the video streams is a video having a wide luminance range, and graphic transition time information indicating a transition time to switch between luminance range adjustment functions when a graphic is combined is stored together.

### TECHNICAL FIELD

Technology disclosed in the description of the present application relates to video content media and video reproduction apparatuses.

### BACKGROUND ART

With an increase in quality of video content, not only a higher resolution but also a wider color gamut and a wider luminance range have been achieved in video equipment. In addition to a conventional relative luminance-based luminance curve, an absolute luminance-based luminance curve has been used.

In Ultra HD Blu-ray®, for example, coding has been performed using an absolute luminance-based luminance curve defined by SMP ST2084, and a wide luminance range of 0.005 nits to 10000 nits is represented.

The luminance curve herein indicates an electro-optical transfer function (EOTF) connecting a code value and luminance.

A consumer-use display apparatus has difficulty representing the above-mentioned luminance range, and thus performs display in a displayable range thereof through adjustment of the luminance range.

For example, in a case where a display apparatus that can perform display at up to 1000 nits displays video content of up to 4000 nits, a luminance range of the video is cut down or is compressed using a luminance conversion function from 4000 nits to 1000 nits.

As a method of converting the luminance range, there are a method of switching between luminance curves and a method of converting a code value of luminance into luminance information, and then performing processing using the luminance conversion function. These methods, however, only differ in procedures and produce the same effects, and thus are handled as the same method in the present description unless otherwise noted.

Adjustment of the luminance range is performed in a reproduction apparatus or in a display apparatus.

Various types of metadata are sometimes added, as hint information, to the video content to efficiently adjust the luminance range. Examples of the metadata include information on maximum peak luminance in content, a maximum value of average luminance for each frame, and whether to give priority to luminance or to gradation, and luminance curve selection information depending on a condition.

The metadata is classified into static metadata that does not change throughout content and dynamic metadata providing hint information most suitable for each scene or frame.

In Ultra HD Blu-ray®, for example, metadata defined by SMPTE ST2086 is used as the static metadata, and dynamic metadata defined by a technology vendor is used as well.

The metadata is used in the reproduction apparatus, in the display apparatus after being transmitted to the display apparatus, or in both of the apparatuses.

Content in Blu-ray Disc® or the like has a graphic function for a menu, subtitles, and the like, and they are combined with a content video and displayed as appropriate. A graphic is combined typically in the reproduction apparatus, transmitted to the display apparatus in a state of being combined with the content video, and displayed. In a case where luminance is adjusted in the display apparatus, a graphic portion as combined is affected by adjustment of the luminance.

Various methods are proposed as technology for adjusting luminance, and the technology is disclosed in Patent Documents 1 and 2, for example.

### PRIOR ART DOCUMENTS

### Patent Documents

Patent Document 1: WO 2016/103968
Patent Document 2: WO 2016/038950

### SUMMARY

### Problem to be Solved by the Invention

In a format, such as Blu-ray Disc®, in which the graphic is transmitted to the display apparatus after being combined with the content video, there is a problem in that luminance of the graphic is fluctuated by dynamic metadata control.

Technology disclosed in the description of the present application is conceived to solve a problem as described above, and it is an object to provide technology for suppressing a change in luminance of a graphic.

### Means to Solve the Problem

A first aspect of the technology disclosed in the description of the present application is a video content medium on which one or more video streams, control information, and graphic information including a menu or a subtitle are recorded, wherein at least one of the video streams is a video having a wide luminance range, and graphic transition time information indicating a transition time to switch between luminance range adjustment functions when a graphic is combined is stored together.

A second aspect of the technology disclosed in the description of the present application is a video reproduction apparatus that reproduces a video content medium on which a video stream, control information, and graphic information including a menu or a subtitle are recorded, wherein graphic transition time information indicating a transition time to switch between luminance range adjustment functions when a graphic is combined is transmitted to a display apparatus that displays a video.

A third aspect of the technology disclosed in the description of the present application is a video reproduction apparatus that reproduces a video content medium on which a video stream, control information, and graphic information including a menu or a subtitle are recorded, wherein, when a graphic is combined, content maximum luminance information in static metadata as the control information is transmitted in place of luminance information in dynamic metadata as the control information to be transmitted to a display apparatus that displays a video.

A fourth aspect of the technology disclosed in the description of the present application is a video reproduction apparatus that reproduces a video content medium on which a video stream, control information, and graphic information including a menu or a subtitle are recorded, wherein the video reproduction apparatus has a function to transmit graphic luminance threshold information to a display apparatus that displays a video, and, when the graphic luminance threshold information is transmitted to the display apparatus, the graphic luminance threshold information is continuously changed over a time determined by graphic transition time information indicating a transition time to switch between luminance range adjustment functions.

### Effects of the Invention

The first aspect of the technology disclosed in the description of the present application is a video content medium on which one or more video streams, control information, and graphic information including a menu or a subtitle are recorded, wherein at least one of the video streams is a video having a wide luminance range, and graphic transition time information indicating a transition time to switch between luminance range adjustment functions when a graphic is combined is stored together. According to such a configuration, a change in luminance of a graphic can be suppressed.

The second aspect of the technology disclosed in the description of the present application is a video reproduction apparatus that reproduces a video content medium on which a video stream, control information, and graphic information including a menu or a subtitle are recorded, wherein graphic transition time information indicating a transition time to switch between luminance range adjustment functions when a graphic is combined is transmitted to a display apparatus that displays a video. According to such a configuration, the change in luminance of the graphic can be suppressed.

The third aspect of the technology disclosed in the description of the present application is a video reproduction apparatus that reproduces a video content medium on which a video stream, control information, and graphic information including a menu or a subtitle are recorded, wherein, when a graphic is combined, content maximum luminance information in static metadata as the control information is transmitted in place of luminance information in dynamic metadata as the control information to be transmitted to a display apparatus that displays a video. According to such a configuration, the change in luminance of the graphic can be suppressed.

The fourth aspect of the technology disclosed in the description of the present application is a video reproduction apparatus that reproduces a video content medium on which a video stream, control information, and graphic information including a menu or a subtitle are recorded, wherein the video reproduction apparatus has a function to transmit graphic luminance threshold information to a display apparatus that displays a video, and, when the graphic luminance threshold information is transmitted to the display apparatus, the graphic luminance threshold information is continuously changed over a time determined by graphic transition time information indicating a transition time to switch between luminance range adjustment functions. According to such a configuration, the change in luminance of the graphic can be suppressed.

The objects, features, aspects, and advantages relating to the technology disclosed in the description of the present application will become more apparent from the following detailed description and the accompanying drawings.

### BRIEF DESCRIPTION OF DRAWINGS

FIG. 1 is a schematic view showing Embodiment 1.

FIG. 2 shows examples of a luminance adjustment curve (in a case where display maximum luminance is 1000 nits).

FIG. 3 shows examples of the luminance adjustment curve (in a case where the display maximum luminance is 400 nits).

FIG. 4 is a schematic view showing combination of luminance adjustment curves.

FIG. 5 is a schematic view showing Embodiment 2.

FIG. 6 shows an example of the luminance adjustment curve (in a case where a graphic luminance threshold is 300 nits, and the display maximum luminance is 1000 nits).

FIG. 7 shows an example of the luminance adjustment curve (in a case where the graphic luminance threshold is 300 nits, and the display maximum luminance is 400 nits).

FIG. 8 shows an example of control using the graphic luminance threshold.

FIG. 9 shows an example of control using the graphic luminance threshold (in a case where there are two thresholds).

FIG. 10 is a schematic view showing Embodiment 3.

FIG. 11 shows an example of luminance adjustment using dynamic metadata.

FIG. 12 shows an example of a storage location of a luminance switching transition time.

FIG. 13 shows examples of storage locations of the graphic luminance threshold and the luminance switching transition time.

### DESCRIPTION OF EMBODIMENTS

Embodiments will be described below with reference to the accompanying drawings.

The drawings are schematically shown, and configurations are omitted or simplified as appropriate for the convenience of description. The sizes of and a positional relationship among configurations shown in different drawings are not necessarily accurate, and can be changed as appropriate.

In description made below, similar components bear the same reference signs, and have similar names and functions. Detailed description thereof is thus sometimes omitted to avoid redundancy.

### Embodiment 1

A video content medium and a video reproduction apparatus relating to the present embodiment will be described below.

A change in luminance of a content video depending on the presence or absence of a graphic causes a viewer discomfort. The viewer feels discomfort, for example, in a case where the luminance of the content video in the background is suddenly changed at a timing of switching on/off of a menu or subtitles.

Described in the embodiment below is technology for reducing discomfort by setting a transition time to switch between typical dynamic metadata processing applied in the absence of the graphic and metadata processing applied in the presence of the graphic to avoid a sudden change in luminance of the content video.

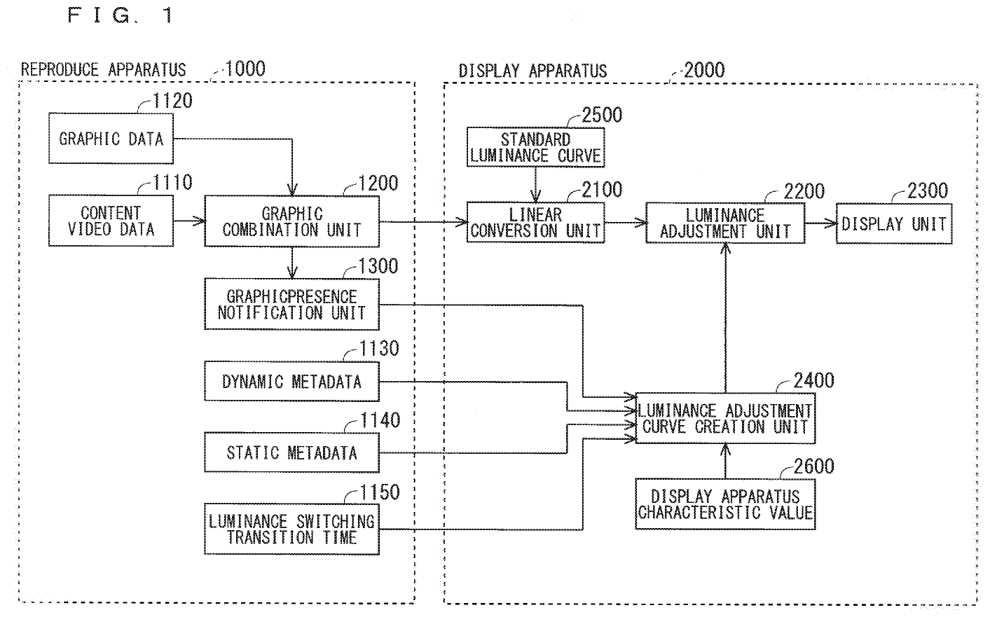

FIG. 1 is a schematic view of a reproduction apparatus 1000 and a display apparatus 2000. As shown in FIG. 1, content video data 1110 as a video stream, graphic data 1120 as graphic information, such as a menu and subtitles, dynamic metadata 1130 as control information, static metadata 1140 as the control information, and a luminance switching transition time 1150 as graphic transition time information are stored, for example, in an optical disc as a video content medium, and are loaded by the reproduction apparatus 1000.

A graphic combination unit 1200 combines the content video data 1110 and the graphic data 1120 to create video data including a graphic. The graphic data is provided in the form of video data, dynamically generated using a program or a command list stored in content, or generated in combination thereof.

The graphic data is data for subtitles or a pop-up menu, for example, and is sometimes switched to be displayed or not displayed with the progress of content reproduction or by a user operation.

The content video data 1110 and the graphic data 1120 are stored in the form of having undergone compression, multiplexing, or the like, and are required to be returned to videos by performing decoding, rendering, or the like before being actually combined, but description thereof is herein omitted for simplicity.

The dynamic metadata 1130 is time-synchronously connected to the content video data 1110, and is stored in a multiplexed stream including the content video data 1110 or as another stream.

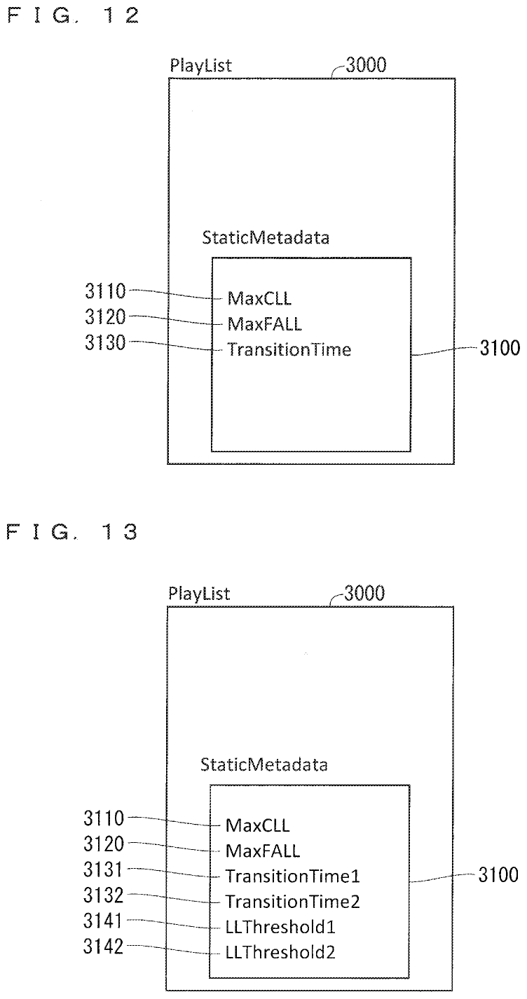

The static metadata 1140 is, for example, a set of pieces of metadata defined by SMPTE ST2086, and stores values of MaxCLL representing maximum luminance of content as a whole, MaxFALL indicating a maximum value of average luminance in each screen, and the like. FIG. 12 shows that content maximum luminance (MaxCLL) 3110 and a content frame average luminance maximum value (MaxFALL) 3120 are stored in static metadata 3100 along with a luminance transition time 3130.

The luminance switching transition time 1150 stores a transition time to switch adjustment of a luminance range. The luminance switching transition time 1150 can be stored at the same location as the other pieces of static metadata as shown by the luminance transition time 3130 in FIG. 12 when being stored in the optical disc and the like, and is read to be used. The luminance switching transition time 1150 can be stored in advance in the reproduction apparatus 1000 and in the display apparatus 2000 as a set value.

A graphic presence notification unit 1300 determines whether a graphic is currently displayed, and transmits the results of determination to the display apparatus 2000.

These pieces of data are transmitted to the display apparatus 2000, for example, through an interface, such as HDMI®. The dynamic metadata 1130, the static metadata 1140, and the luminance switching transition time 1150 are transmitted as pieces of data in a different system from video data referred to as InfoFrame. Alternatively, the dynamic metadata 1130, the static metadata 1140, and the luminance switching transition time 1150 are sometimes transmitted to the display apparatus 2000 in a state of being superimposed on a video signal. Notification data created by the graphic presence notification unit 1300 is transmitted in a similar manner.

A linear conversion unit 2100 converts the content video data from a code value to a linear value representing a content luminance value in accordance with a conversion curve of a standard luminance curve 2500. A luminance adjustment unit 2200 converts the content luminance value into luminance in actual display in accordance with characteristics of the display apparatus. A display unit 2300 displays a content video using a value of the luminance adjusted by the luminance adjustment unit 2200.

Examples of a display apparatus characteristic value include a luminance range in which the display unit 2300 can perform display, an image quality adjustment value for a cinema mode, a sport mode, or the like, and optical information in an environmental around the display apparatus. A luminance adjustment curve creation unit 2400 creates a luminance adjustment curve suitable for a condition using a display apparatus characteristic value 2600, the dynamic metadata 1130, the static metadata 1140, and the luminance switching transition time 1150 to control the luminance adjustment unit 2200.

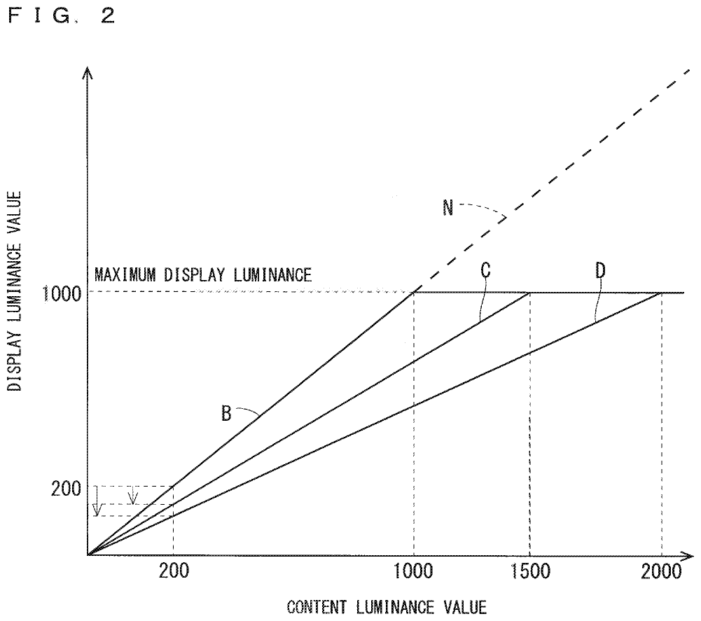

Operations of the luminance adjustment unit 2200 and the luminance adjustment curve creation unit 2400 will be described with use of FIG. 2. FIG. 2 shows an example in a case where maximum display luminance of the display unit 2300 is 1000 nits. Although the luminance adjustment curve is drawn as a straight line for simplicity, a curve is often used in actuality in consideration of human visual characteristics.

The horizontal axis in FIG. 2 is absolute value representation of the content luminance value of video data. In a case of video data represented by ST2084, a luminance range of up to 10000 nits can be represented.

The vertical axis in FIG. 2 is a display luminance value in actual display on a screen. In a case of an ideal display apparatus including the display unit 2300 that can perform display at up to 10000 nits, the content luminance value and the display luminance value are the same. That is to say, the luminance adjustment curve is a straight line N showing a ratio of 1:1 in FIG. 2, and is not required to be changed.

The display unit 2300 cannot necessarily perform display at up to 10000 nits in actuality. A television currently on the market can perform display at up to 400 nits or less when it is of a low-end model, and can perform display at up to around 1000 nits when it is of a high-end model characterized by support for high luminance.

In a case where display is tried to be performed at the content luminance value as it is, display is performed faithfully to the content luminance value at up to the maximum display luminance, but, at above the maximum display luminance, is performed at the maximum display luminance due to clipping, as shown by a luminance adjustment curve B. In this case, a portion of a video having luminance higher than the maximum display luminance is to be impaired.

The luminance adjustment curve is thus changed using a maximum value of content luminance. That is to say, the luminance adjustment curve B, a luminance adjustment curve C, and a luminance adjustment curve D are respectively used in cases where the maximum value of the content luminance is 1000 nits or less, 1500 nits, and 2000 nits.

As a criterion when the luminance adjustment curve is created, a maximum luminance value of content as a whole is used in static metadata control, and a maximum luminance value for each scene or frame is used in dynamic metadata control.

Although the luminance adjustment curve is herein described to be created using the maximum luminance value of content, the luminance adjustment curve is actually created in consideration of an average luminance value of content, whether to put an emphasis on high luminance or on low luminance, setting of an image quality mode, ambient light, and the like.

In the static metadata control, the luminance adjustment curve is not changed from the start till the end of reproduction of a content video. If the maximum luminance value of content is 2000 nits, the luminance adjustment curve D is applied to the content as a whole. A change in luminance not occurring in an original video thus does not occur during reproduction.

On the other hand, content is reproduced while reducing luminance of the content as a whole even if a scene having a high luminance is only partially present, and thus the content as a whole gives a dark impression. Furthermore, due to a high compression ratio of the luminance range, gradation of luminance is more likely to be impaired.

In the dynamic metadata control, the luminance adjustment curve is changed, for example, for each scene during reproduction of the content video. The luminance adjustment curve B is applied if a scene during reproduction has luminance of up to 1000 nits, and the luminance adjustment curve D is applied to a scene having luminance of up to 2000 nits. As a luminance adjustment curve most suitable for each scene is used, gradation of luminance is less likely to be impaired.

On the other hand, reference brightness varies depending on the scene. For example, the same landscape is displayed darkly as a whole when the sun is in the angle of view, and is displayed brightly as a whole when the sun is not in the angle of view.

Such a change in luminance does not cause any problem in a normal scene. As human vision is also changed depending on a condition, a change in luminance of an image caused when a scene is changed causes little discomfort.

A change in luminance caused by the dynamic metadata control becomes a problem in a case where a graphic, such as subtitles and a pop-up menu, is displayed. The graphic is displayed independently of the scene, and is thus expected by a user to be displayed at the same luminance regardless of the scene, and a change in luminance in a graphic portion caused by a change in luminance adjustment curve in the dynamic metadata control causes significant discomfort.

FIG. 2 shows an example in a case where a graphic is rendered at a content luminance value of 200 nits. The display luminance value is 200 nits as with the content luminance value when the luminance adjustment curve B is used, but, when the luminance adjustment curve is switched to the luminance adjustment curve D by a change in video, is changed to a value smaller than 200 nits although the graphic is not changed.

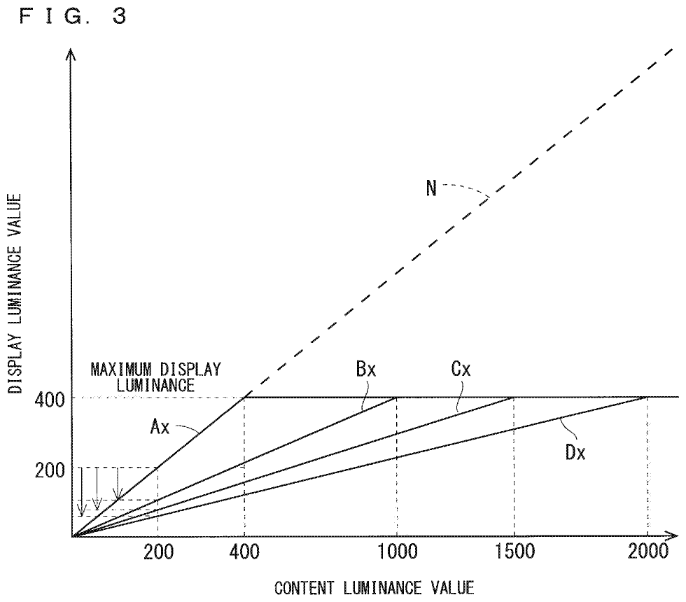

This change becomes noticeable in a case where the display unit 2300 has low maximum display luminance. FIG. 3 shows an example in a case where the maximum display luminance is 400 nits. The luminance adjustment curves are changed to luminance adjustment curves Ax, Bx, Cx, and Dx in accordance with the maximum display luminance.

When maximum luminance of content is changed from 400 nits to 2000 nits in a case where a graphic is rendered at 200 nits, the luminance adjustment curve is changed from the luminance adjustment curve Ax to the luminance adjustment curve Dx, and a graphic portion rendered at 200 nits is changed to be rendered at a value smaller than 200 nits.

As a method for preventing such a change in luminance in a graphic portion, a method of fixing a luminance conversion curve without performing the dynamic metadata control when a graphic is displayed is considered. For example, the dynamic metadata control is switched to the static metadata control in a case where a graphic is switched to be displayed, and the static metadata control is switched to the dynamic metadata control in a case where a graphic is switched to be not displayed. Alternatively, in a case where a graphic is switched to be displayed, control is performed so that the luminance conversion curve is fixed to the luminance conversion curve created in the dynamic metadata control at the time so as not to thereafter reflect a value of the dynamic metadata, and, in a case where a graphic is switched to be not displayed, the dynamic metadata control is performed again so that the value of the dynamic metadata is thereafter reflected.

As described above, the change in luminance in the graphic portion when the graphic is displayed can be suppressed by changing control of the luminance conversion curve depending on the presence or absence of the graphic. On the other hand, as the luminance conversion curve is changed depending on the presence or absence of the graphic, a change in luminance is caused in the content video independently of the scene during reproduction to cause other discomfort.

In the present embodiment, a method for reducing discomfort at the time of switching caused in a method of switching control of the luminance curve depending on the presence or absence of the graphic by setting a transition time will be described.

The reproduction apparatus 1000 in FIG. 1 reads the luminance transition time 3130 stored in playlist data 3000 on the optical disc in FIG. 12, and uses the luminance transition time 3130 as the luminance switching transition time 1150.

The reproduction apparatus 1000 transmits the luminance switching transition time 1150 to the display apparatus 2000 through the interface, such as HDMI®. Upon receiving the luminance switching transition time 1150, the display apparatus 2000 sets the luminance switching transition time 1150 to one of parameters used by the luminance adjustment curve creation unit 2400. The dynamic metadata 1130 and the static metadata 1140 are similarly transmitted to the luminance adjustment curve creation unit 2400.

In a case where a graphic, such as subtitles and a menu, is displayed by an operation of a user or with the progress of reproduction, the graphic presence notification unit 1300 notifies, from the reproduction apparatus 1000, the display apparatus 2000 that the graphic is displayed.

Notification that the graphic is displayed can be provided by setting a flag indicating that the graphic is displayed to the interface. Notification that the graphic is displayed can also be provided by switching a flag indicating an HDR type defined by an HDMI® interface. Alternatively, notification that the graphic is displayed can be detected by the display apparatus 2000 by stopping transmission of the dynamic metadata.

Upon detecting notification that the graphic is displayed from the graphic presence notification unit 1300, the luminance adjustment curve creation unit 2400 stops the dynamic metadata processing, and transmits a fixed luminance adjustment curve to the luminance adjustment unit 2200 instead.

The fixed luminance adjustment curve indicates the luminance adjustment curve created using the static metadata 1140, for example. In this case, simple switching of processing causes, for example, switching from the luminance adjustment curve B to the luminance adjustment curve D in FIG. 2 to cause a sudden decrease in luminance of a content video during reproduction independently of the scene. The luminance adjustment curve to be used is thus continuously changed over a time designated by the luminance switching transition time 1150.

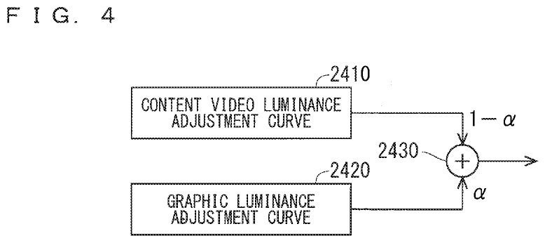

FIG. 4 is a schematic view of switching of metadata processing in the display apparatus. A content video luminance adjustment curve 2410 is a luminance adjustment curve created using the dynamic metadata 1130 and being suitable for the content video, for example. A graphic luminance adjustment curve 2420 is a luminance adjustment curve created using only the static metadata 1140 and being suitable for a graphic having luminance that does not change, for example.

The static metadata 1140 is stored beforehand in the luminance adjustment curve creation unit 2400. The luminance adjustment curve applied to an output video is obtained by a combination unit 2430 combining these luminance adjustment curves at a combination ratio α. For graphic luminance adjustment, not the static metadata but the dynamic metadata can be used so that a luminance adjustment value is the same at or below a threshold.

At the time of switching, switching can smoothly be performed by the combination unit 2430 continuously changing the combination ratio α from 0 to 1 over the time designated by the luminance switching transition time 1150, for example.

The same applies to a case where the graphic is switched to be not displayed. Upon receiving notification that the graphic is not displayed from the graphic presence notification unit 1300, the luminance adjustment curve creation unit 2400 resumes the dynamic metadata control. In this case, the combination ratio α is continuously changed from 1 to 0 over the time designated by the luminance switching transition time to achieve smooth transition to the dynamic metadata control.

As described above, discomfort caused by switching between luminance adjustment curves when the graphic is displayed can be reduced.

Although the operation of the luminance adjustment curve creation unit 2400 is simply switched depending on the presence or absence of the graphic in the above-mentioned embodiment, in a case of a graphic, such as subtitles, repeatedly switched to be displayed or not displayed in a short time, a method of handling temporally adjacent graphics as a group of graphics so as not to perform switching of the operation of the luminance adjustment curve creation unit 2400 depending on whether an individual graphic is displayed or not displayed can be used.

### Embodiment 2

A video content medium and a video reproduction apparatus relating to the present embodiment will be described below. In description made below, similar components to those described in the above-mentioned embodiment bear the same reference signs as those in the above-mentioned embodiment, and detailed description thereof is omitted as appropriate. A modification of Embodiment 1 will be described below.

It is considered that luminance adjustment is performed so that luminance does not change at or below a graphic luminance threshold in the dynamic metadata control by using a luminance adjustment curve having a common value at or below the graphic luminance threshold and having different values at or above the graphic luminance threshold.

Fluctuations of luminance of the graphic can be suppressed in the dynamic metadata control by setting the graphic luminance threshold to a value greater than the maximum luminance value used for the graphic.

On the other hand, in a luminance range at or below the threshold, the static metadata control is substantially performed to impair gradation. It is thus considered that a luminance adjustment curve having the threshold and a luminance adjustment curve not having the threshold are used in combination while being switched therebetween. In this case, the change in luminance is caused at the time of switching independently of the scene as in Embodiment 1. In the present embodiment, a method for reducing discomfort caused by the change in luminance at the time of switching of the luminance conversion curve having the threshold will be described.

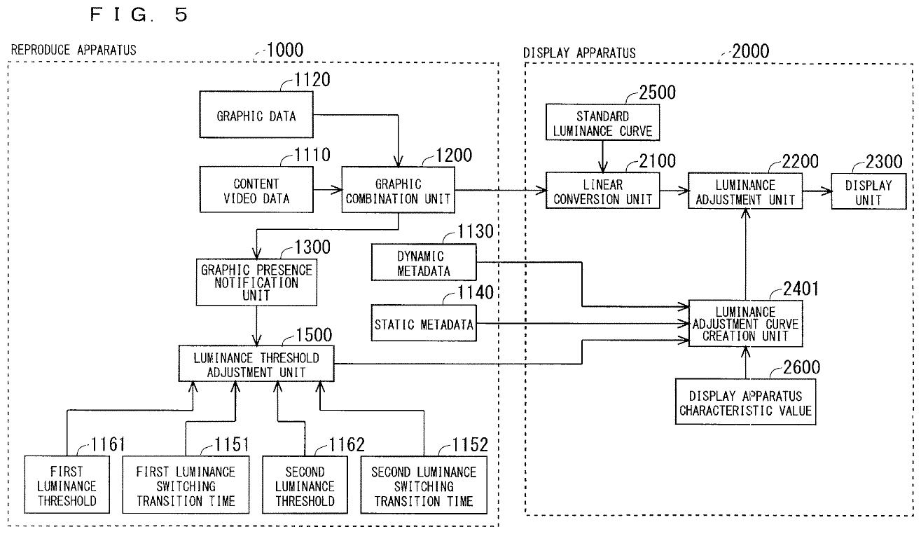

FIG. 5 is a schematic view for describing the present embodiment, reference signs 1161 and 1162 respectively represent a first luminance threshold and a second luminance threshold, and reference signs 1151 and 1152 respectively represent a first luminance switching transition time and a second luminance switching transition time.

Description is herein made using the two graphic luminance thresholds and the two luminance switching transition times, but the number of graphic luminance thresholds and the number of luminance switching transition times each may be one or two or more. A luminance threshold adjustment unit 1500 adjusts the graphic luminance thresholds depending on a condition. The graphic luminance thresholds adjusted by the luminance threshold adjustment unit 1500 are transmitted to the display apparatus 2000.

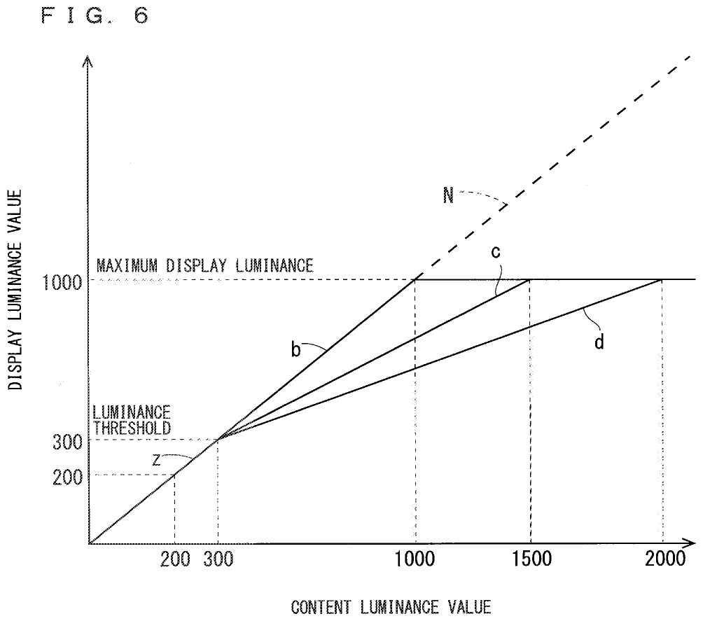

FIG. 6 shows an example of the luminance adjustment curve used in the present embodiment. Although the graphic luminance threshold in FIG. 6 is described as the first luminance threshold 1161, the same applies to a case where the graphic luminance threshold is the second luminance threshold 1162.

When receiving the first luminance threshold 1161, a luminance adjustment curve creation unit 2401 creates a luminance adjustment curve having the same value (z in FIG. 6) at or below luminance set by the first luminance threshold 1161 and having different values (b, c, and d in FIG. 6) depending on content luminance at or above the luminance set by the first luminance threshold 1161.

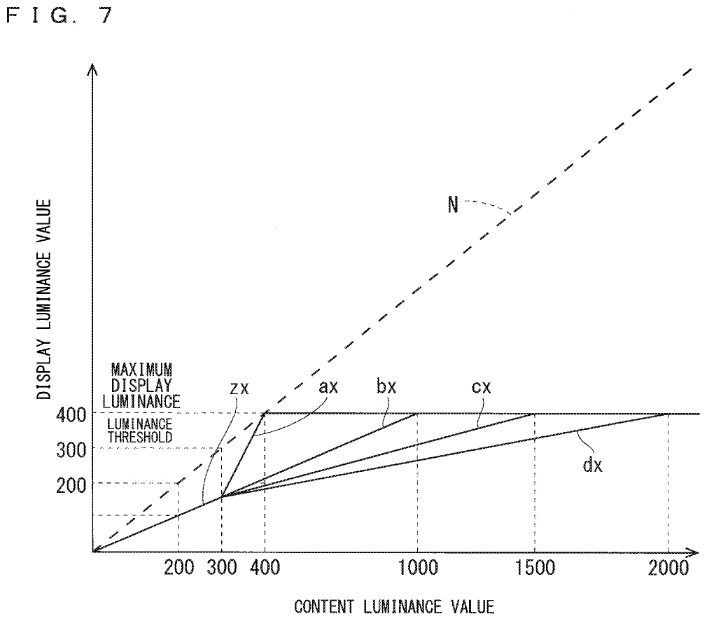

FIG. 6 shows an example in a case where the maximum display luminance of the display unit 2300 is 1000 nits. FIG. 7 shows an example in a case where the maximum display luminance of the display unit 2300 is 400 nits (see zx, ax, bx, cx, and dx in FIG. 7).

As described above, fluctuations of the luminance caused by luminance adjustment can be suppressed in a region in which the luminance is lower than the luminance set by the first luminance threshold 1161 while performing the dynamic metadata control in a region in which the luminance is higher than the luminance set by the first luminance threshold 1161.

The graphic luminance threshold is continuously changed to reduce discomfort caused by the change in luminance of a video caused when switching is performed between the luminance adjustment curve having the threshold and the luminance adjustment curve not having the threshold.

Upon receiving notification that the first luminance threshold 1161 is to be applied from the graphic presence notification unit 1300, the luminance threshold adjustment unit 1500 creates the graphic luminance threshold to be transmitted to the display apparatus 2000 using the first luminance threshold 1161 and the first luminance switching transition time 1151.

A graphic can be switched to be displayed or not displayed with the progress of content reproduction or by an operation of a user.

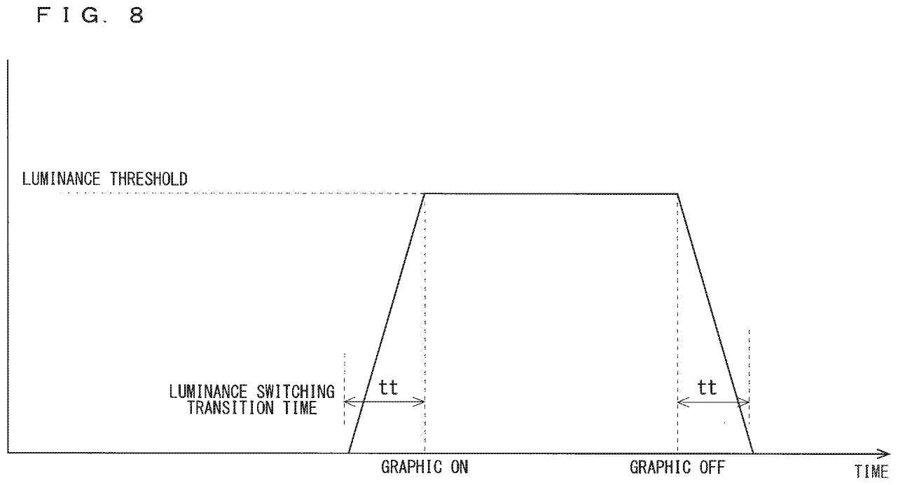

FIG. 8 shows an example of the graphic luminance threshold transmitted from the luminance threshold adjustment unit 1500. In a state of the first luminance threshold 1161 not being applied, the graphic luminance threshold transmitted from the luminance threshold adjustment unit 1500 is 0. When the first luminance threshold 1161 is to be applied, for example, when a graphic is switched to be displayed, the luminance threshold adjustment unit 1500 continuously increases a value of the graphic luminance threshold to be transmitted over a time designated by the first luminance switching transition time 1151 so that the value designated by the first luminance threshold 1161 becomes the graphic luminance threshold to be transmitted.

When the luminance threshold adjustment unit 1500 is not to be applied, for example, when the graphic is switched to be not displayed, the luminance threshold adjustment unit 1500 continuously decreases the graphic luminance threshold to be transmitted from the value designated by the first luminance threshold 1161 to 0 over the time designated by the first luminance switching transition time 1151.

As described above, switching of the luminance curve is continuously performed to enable a smooth change in luminance to thereby reduce discomfort.

Use of two graphic luminance thresholds having different values is sometimes convenient. It is convenient, for example, in a case where graphics having difference luminance ranges are used for subtitles and a pop-up menu.

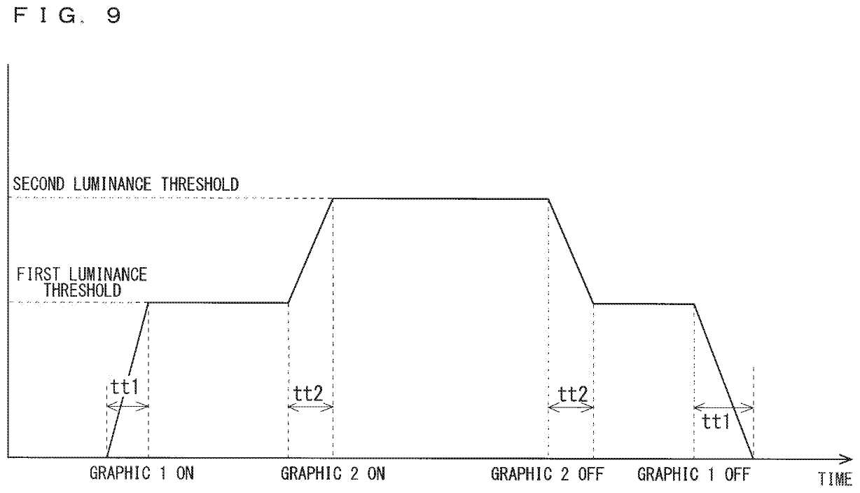

FIG. 9 shows an example in a case where two graphic luminance thresholds are used. In a case where the first luminance threshold 1161 or the second luminance threshold 1162 is applied alone, processing similar to that described above is performed. In a case where both the first luminance threshold 1161 and the second luminance threshold 1162 are applied, the luminance threshold adjustment unit 1500 transmits a greater one of values of the graphic luminance thresholds.

Description is made on the assumption that the first luminance threshold 1161 is greater than the second luminance threshold 1162. When a graphic to which the first luminance threshold 1161 is applied is displayed, the graphic luminance threshold is switched to the first luminance threshold 1161 over the time designated by the first luminance switching transition time 1151, and, when a graphic to which the second luminance threshold 1162 is applied is displayed in this state, the graphic luminance threshold is switched to the second luminance threshold 1162 over a time designated by the second luminance switching transition time 1152. The same applies to a case where the graphic is switched to be not displayed.

As the luminance threshold adjustment unit 1500 uses the greatest one of values of applicable graphic luminance thresholds as the graphic luminance threshold to be transmitted, the graphic luminance threshold transmitted from the luminance threshold adjustment unit 1500 does not change if the graphic to which the first luminance threshold 1161, which has a smaller set value, is applied is switched to be displayed or not displayed while the graphic to which the second luminance threshold 1162, which has a greater set value, is applied is displayed.

FIG. 13 shows that the content maximum luminance (MaxCLL) 3110, the content frame average luminance maximum value (MaxFALL) 3120, a first luminance transition time 3131, a second luminance transition time 3132, a first luminance threshold 3141, and a second luminance threshold 3142 are stored in the static metadata 3100.

Although two times, that is, the first luminance switching transition time 1151 and the second luminance switching transition time 1152, are herein stored, a single luminance switching transition time may be stored to switch the first luminance threshold 1161 and the second luminance threshold 1162 over the same time.

As described above, in a case where the luminance adjustment curve having the threshold is used, discomfort caused by the change in luminance caused by a change in display state of a graphic can be reduced by setting the transition time.

Although the luminance threshold adjustment unit 1500 is herein described to be included in the reproduction apparatus 1000, the luminance threshold adjustment unit 1500 can be included, for example, in the luminance adjustment curve creation unit 2401 of the display apparatus 2000.

In this case, the first luminance threshold 1161, the second luminance threshold 1162, the first luminance switching transition time 1151, and the second luminance switching transition time 1152 are transmitted in advance to the display apparatus 2000.

### Embodiment 3

A video content medium and a video reproduction apparatus relating to the present embodiment will be described below. In description made below, similar components to those described in the above-mentioned embodiment bear the same reference signs as those in the above-mentioned embodiment, and detailed description thereof is omitted as appropriate.

While description is made in Embodiment 1 so that the display apparatus can adjust the combination ratio in accordance with the transition time, an example in which the reproduction apparatus performs processing of the graphic transition time will be described below as a modification.

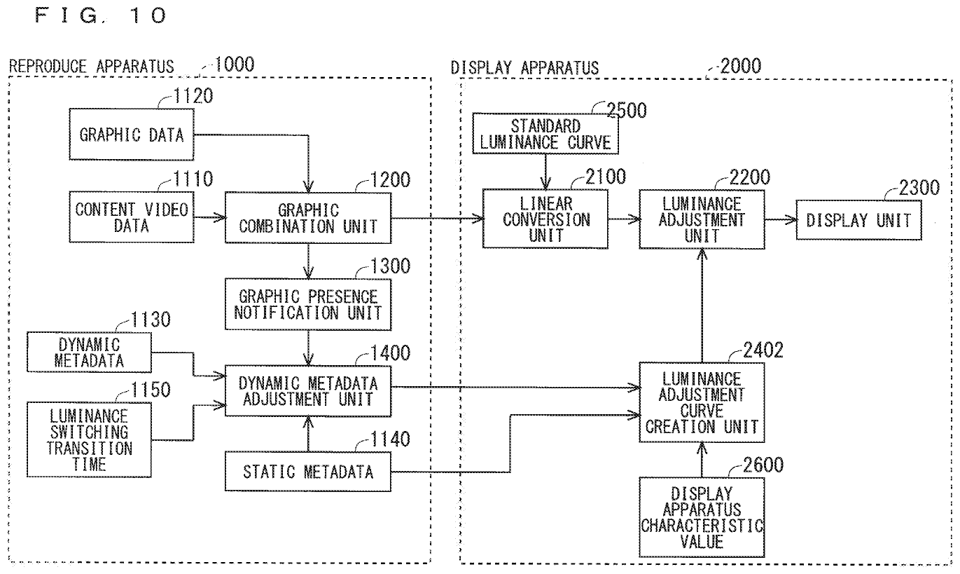

FIG. 10 shows an example in which the reproduction apparatus performs processing of the graphic transition time using the dynamic metadata. An example in a case where switching is performed between the dynamic metadata and the static metadata is herein described. A dynamic metadata adjustment unit 1400 adjusts the dynamic metadata, and transmits the adjusted dynamic metadata to a luminance adjustment curve creation unit 2402 of the display apparatus 2000.

A value of the dynamic metadata is herein fixed to a value of the static metadata when a graphic is displayed so that the static metadata control is switched to be substantially performed. This enables continuous switching of the metadata control in contrast to a case where switching is performed simply between the dynamic metadata control and the static metadata control.

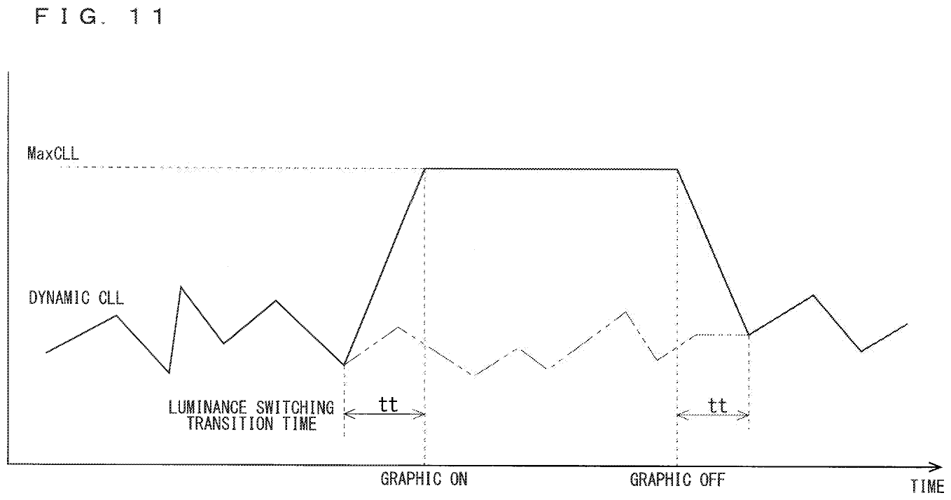

FIG. 11 shows an example of the dynamic metadata in this example. Dynamic CLL represents a peak luminance value for each scene or frame included in the dynamic metadata 1130. MaxCLL represents a peak luminance value throughout content included in the static metadata 1140. Although control of information other than the peak luminance value is actually required to be performed because the luminance adjustment curve is created to include the information other than the peak luminance value, description is herein made only on the peak luminance value.

During normal reproduction of a content video, the dynamic metadata adjustment unit 1400 transmits the peak luminance information in the dynamic metadata 1130 to the display apparatus 2000 as it is. It corresponds to a portion of a solid zigzag line represented by the dynamic CLL in FIG. 11.

Upon receipt of notification that a graphic is displayed from the graphic presence notification unit 1300, the peak luminance value is continuously changed to a value of MaxCLL included in the static metadata 1140 over the time designated by the luminance switching transition time 1150 (a portion shown by tt in FIG. 11).

The dynamic metadata originally corresponds to a portion of a dashed zigzag line in FIG. 11, but the dynamic metadata transmitted to the display apparatus 2000 has a value shown by the solid line when the graphic is displayed.

As the display apparatus 2000 creates the luminance adjustment curve using the value of the dynamic metadata received from the dynamic metadata adjustment unit 1400, fluctuations of luminance in the graphic portion can be suppressed by fixing the value of the dynamic metadata.

As described above, the reproduction apparatus 1000 adjusts the value of the dynamic metadata, so that the static metadata control can substantially be performed using a mechanism of the dynamic metadata control while reducing discomfort caused with switching by setting the transition time.

When the graphic is displayed, fluctuations of luminance in the graphic portion can be suppressed by temporarily transmitting the value of MaxCLL in the static metadata to the display apparatus as the peak luminance information in the dynamic metadata while ignoring original peak luminance information in the dynamic metadata. In this case, the peak luminance information in the dynamic metadata immediately before the graphic is displayed is changed to the value of MaxCLL over the designated graphic transition time to avoid a sudden change in luminance of a content video.

As described above, the graphic transition time is applied in accordance with content at the time of switching between luminance adjustment methods to provide a viewing environment causing little discomfort when the graphic is switched to be displayed or not displayed.

In the embodiments described above, dimensions of, shapes of, a relative positional relationship among, or conditions for performance of components are sometimes described, but they are each one example in all aspects, and are not limited to those described in the description of the present application.

Numerous modifications not having been described and the equivalent can be devised within the scope of the technology disclosed in the description of the present application. For example, a case where at least one component is modified, added, or omitted and, further, a case where at least one component in at least one embodiment is extracted and combined with components in another embodiment are included.

### Explanation of Reference Signs

1000 reproduction apparatus, 1110 content video data, 1120 graphic data, 1130 dynamic metadata, 1140 and 3100 static metadata, 1150 luminance switching transition time, 1151 first luminance switching transition time, 1152 second luminance switching transition time, 1500 luminance threshold adjustment unit, 1161 and 3141 first luminance threshold, 1162 and 3142 second luminance threshold, 1200 graphic combination unit, 1300 graphic presence notification unit, 1400 dynamic metadata adjustment unit, 2000 display apparatus, 2100 linear conversion unit, 2200 luminance adjustment unit, 2300 display unit, 2400, 2401, and 2402 luminance adjustment curve creation unit, 2410 content video luminance adjustment curve, 2420 graphic luminance adjustment curve, 2430 combination unit, 2500 standard luminance curve, 2600 display apparatus characteristic value, 3000 playlist data, 3110 content maximum luminance (MaxCLL), 3120 content frame average luminance maximum value (MaxFALL), 3130 luminance transition time, 3131 first luminance transition time, 3132 second luminance transition time, Ax, B, Bx, C, Cx, D, and Dx luminance adjustment curve.

1. A video content medium on which one or more video streams and graphic information including a menu and a subtitle are recorded, wherein
at least one of the video streams is a video having a wide luminance range,
the video content medium includes static metadata in which an adjustment value used for luminance adjustment functions does not change and dynamic metadata in which the adjustment value changes,
when a graphic is combined, the static metadata and the dynamic metadata are used while being switched therebetween,
graphic transition time information indicating a transition time to switch between the static metadata and the dynamic metadata and the graphic information are stored together, and
a video reproduction apparatus is enabled to switch between the luminance adjustment functions and to switch between the luminance adjustment functions over a time designated by the transition time when the graphic is combined.

2. A video reproduction apparatus that reads, from a video content medium, and reproduces a video stream and graphic information including a menu and a subtitle, wherein
the video reproduction apparatus has a luminance adjustment function in a static metadata scheme in which an adjustment value to be used does not change and a luminance adjustment function in a dynamic metadata scheme in which the adjustment value changes,
when a graphic is combined, the luminance adjustment functions are used while being switched therebetween, and
graphic transition time information read from the video content medium is used as a transition time to switch between the luminance range adjustment functions.

3-5. (canceled)
